(19) United States
(12) Patent Application Publication
(10) Pub. No.: US 2026/0261925 A1
(43) Pub. Date: Sep. 3, 2026

(54) NETWORK HANDOVER ENHANCEMENT METHOD, NETWORK SYSTEM, AND NETWORK NODE

(71) Applicant: SHENZHEN TCL NEW TECHNOLOGY CO., LTD., Shenzhen, Guangdong (CN)

(72) Inventors: Xin ZHANG, Shenzhen, Guangdong (CN); Yincheng ZHANG, Shenzhen, Guangdong (CN)

(73) Assignee: SHENZHEN TCL NEW TECHNOLOGY CO., LTD., Shenzhen, Guangdong (CN)

(21) Appl. No.: 19/155,551

(22) PCT Filed: Apr. 25, 2023
(86) PCT No.: PCT/CN2023/090711

§ 371 Date: Aug. 11, 2025

(51) Int. Cl. H04W 36/00; H04W 84/06

(52) U.S. Cl. CPC H04W 36/0072; H04W 84/06

(57) ABSTRACT

A network handover enhancement method by a network system includes transmitting, by a network node of the network system to a serving/source node and one or more target nodes of the network system, data before a handover procedure. A network system includes a network node, a serving/source node, and/or one or more target nodes. The network node, the serving/source node, and/or the one or more target nodes is configured to execute the network handover enhancement method.

### BACKGROUND OF DISCLOSURE

### 1. Field of the Disclosure

The present disclosure relates to the field of wireless communication systems such as non-terrestrial network (NTN) systems, and more particularly, to network handover enhancement methods such as NTN-NTN handover, network systems, and network nodes.

### 2. Description of the Related Art

The current work considers existing methods from new radio (NR) terrestrial network (TN) as well as Rel-17 NR NTN work item (WI) outcome as baseline for NTN-TN mobility. The mobility related objective of this WI includes specifying NTN-TN and NTN-NTN measurement/mobility and service continuity enhancements and further includes specifying NTN-NTN handover enhancement for RRC CONNECTED UEs in the quasi-earth-fixed cell and earth-moving cell to reduce the signaling overhead.

In non-geosynchronous orbit (NGSO) scenarios, satellites (especially low-earth orbits (LEO) satellites) are featured as high-speed moving. Considering some scenarios, the relative speed of LEO satellite with respect to the earth can be as high as 7.56 km per second (i.e., 27216 km/h), which is in the level of 100× times compared to high-speed train. No matter whether UE is moving or stationary, this means that in the LEO scenario, almost all UEs in the same cell may encounter frequent handovers in very short period. If existing handover command is adopted, this would result in a lot of signaling overhead and especially these signaling may happen in a burst, since handover command is now carried in dedicated radio resource control (RRC) signaling in the form of RRCReconfiguration message.

Signaling burst raises challenges to the network since network may not have sufficient radio resources to transmit handover command for each concerned UE within short time. As a consequence, some UE's handover commands may reach later than others and this may cause too late handover and even handover failures. Therefore, there is an open issue to reduce the handover (HO) command signaling load.

### SUMMARY

An object of the present disclosure is to propose network handover enhancement methods, network systems, and network nodes, which can reduce a signaling load during a HO procedure such as NTN-NTN HO procedure.

In a first aspect of the present disclosure, a network handover enhancement method by a network system includes transmitting, by a network node of the network system to a serving/source node and one or more target nodes of the network system, data before a handover procedure.

In a second aspect of the present disclosure, a network handover enhancement method by a network node includes transmitting, by the network node to a serving/source node and one or more target nodes, data before a handover procedure.

In a third aspect of the present disclosure, a network system includes a network node, a serving/source node, and/or one or more target nodes. The network node, the serving/source node, and/or the one or more target nodes is configured to execute the above network handover enhancement method.

In a fourth aspect of the present disclosure, a network node includes a memory, a transceiver, and a processor coupled to the memory and the transceiver. The transceiver is configured to transmit data to a serving/source node and one or more target nodes before a handover procedure.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of a network node, a serving/source node, and/or one or more target nodes of communication in a network system according to an embodiment of the present disclosure.

FIG. 2 is a flowchart illustrating a network handover enhancement method by a network system according to an embodiment of the present disclosure.

FIG. 3 is a flowchart illustrating a network handover enhancement method by a network node according to an embodiment of the present disclosure.

FIG. 4 is a schematic diagram illustrating a networking-RAN architecture with transparent satellite according to an embodiment of the present disclosure.

FIG. 5 is a schematic diagram illustrating a regenerative satellite without ISL, gNB processed payload according to an embodiment of the present disclosure.

FIG. 6 is a schematic diagram illustrating a regenerative satellite with ISL, gNB processed payload according to an embodiment of the present disclosure.

FIG. 7 is a schematic diagram illustrating a NG-RAN with a regenerative satellite based on gNB-DU according to an embodiment of the present disclosure.

FIG. 8A is a flowchart illustrating a network handover enhancement method according to an embodiment of the present disclosure.

FIG. 8B is a flowchart illustrating a network handover enhancement method according to an embodiment of the present disclosure.

FIG. 8C is a flowchart illustrating a network handover enhancement method according to an embodiment of the present disclosure.

FIG. 9 is a flowchart illustrating a network handover enhancement method according to an embodiment of the present disclosure.

FIG. 10 is a flowchart illustrating a network handover enhancement method according to an embodiment of the present disclosure.

FIG. 11 is a flowchart illustrating a network handover enhancement method according to an embodiment of the present disclosure.

FIG. 12 is a flowchart illustrating a network handover enhancement method according to an embodiment of the present disclosure.

FIG. 13A is a flowchart illustrating a network handover enhancement method according to an embodiment of the present disclosure.

FIG. 13B is a flowchart illustrating a network handover enhancement method according to an embodiment of the present disclosure.

FIG. 14 is a flowchart illustrating a network handover enhancement method according to an embodiment of the present disclosure.

FIG. 15 is a flowchart illustrating a network handover enhancement method according to an embodiment of the present disclosure.

FIG. 16 is a flowchart illustrating a network handover enhancement method according to an embodiment of the present disclosure.

FIG. 17 is a flowchart illustrating a network handover enhancement method according to an embodiment of the present disclosure.

FIG. 18 is a flowchart illustrating a network handover enhancement method according to an embodiment of the present disclosure.

FIG. 19 is a flowchart illustrating a network handover enhancement method according to an embodiment of the present disclosure.

FIG. 20 is a flowchart illustrating a network handover enhancement method according to an embodiment of the present disclosure.

FIG. 21 is a flowchart illustrating a network handover enhancement method according to an embodiment of the present disclosure.

FIG. 22 is a flowchart illustrating a network handover enhancement method according to an embodiment of the present disclosure.

FIG. 23 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In some embodiments, the network refers to nodes in an NTN system including one of the following nodes, for example: 1. space-borne vehicle (such as satellite), airborne vehicle, aerial vehicle (such as drone), etc. 2. Base station. 3. Gateway. 4. Core Network. The NTN system includes nodes such as satellite, gateways, base station, and core network, etc. The network in some embodiments of this disclosure refers to any node in the NTN system. The “satellite” my be divided into many types, including space-borne vehicle (such as satellite), airborne vehicle, aerial vehicle (such as drone), etc.

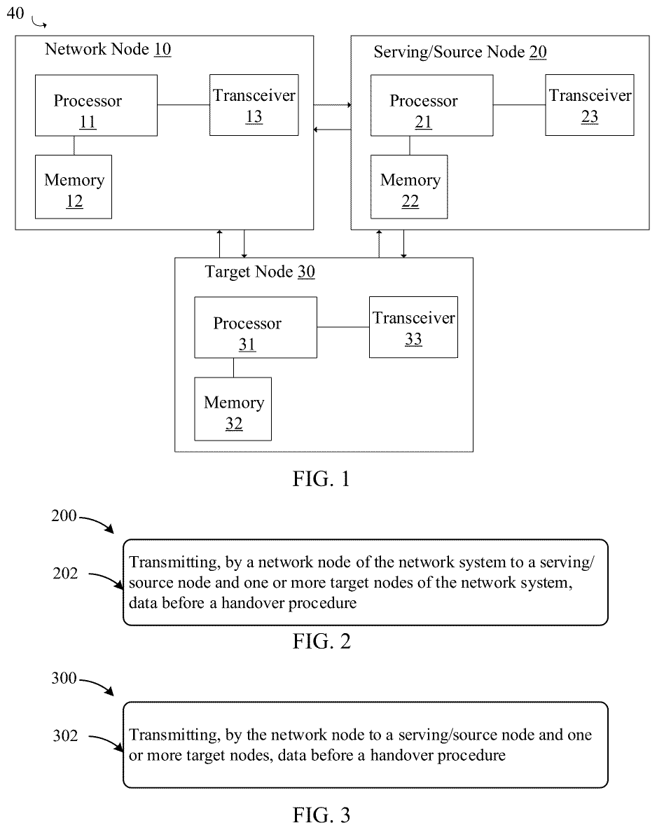

FIG. 1 illustrates that, in some embodiments, a network node 10, a serving/source node 20, and/or one or more target nodes 30 of communication in a network system 40 according to an embodiment of the present disclosure are provided. The network system 40 includes the network node 10, the serving/source node 20, and/or the one or more target nodes 30. The network node 10 may include a memory 12, a transceiver 13, and a processor 11 coupled to the memory 12 and the transceiver 13. The serving/source node 20 may include a memory 22, a transceiver 23, and a processor 21 coupled to the memory 22 and the transceiver 23. The one or more target nodes 30 may include a memory 32, a transceiver 33, and a processor 31 coupled to the memory 32 and the transceiver 33. The processor 11, 21, or 31 may be configured to implement proposed functions, procedures and/or methods described in this description. Layers of radio interface protocol may be implemented in the processor 11, 21, or 31. The memory 12, 22, or 32 is operatively coupled with the processor 11, 21, or 31 and stores a variety of information to operate the processor 11, 21, or 31. The transceiver 13, 23, or 33 is operatively coupled with the processor 11, 21, or 31, and the transceiver 13, 23, or 33 transmits and/or receives a radio signal.

The processor 11, 21, or 31 may include application-specific integrated circuit (ASIC), other chipset, logic circuit and/or data processing device. The memory 12, 22, or 32 may include read-only memory (ROM), random access memory (RAM), flash memory, memory card, storage medium and/or other storage device. The transceiver 13, 23, or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22, or 32 and executed by the processor 11, 21, or 31. The memory 12, 22, or 32 can be implemented within the processor 11, 21, or 31 or external to the processor 11, 21, or 31 in which case those can be communicatively coupled to the processor 11, 21, or 31 via various means as is known in the art. Further, in some embodiments, the processor 11 is configured to perform the following methods. Further, in some embodiments, the processor 21 is configured to perform the following methods.

FIG. 2 is a flowchart illustrating a network handover enhancement method 200 by a network system according to an embodiment of the present disclosure. In some embodiments, the network handover enhancement method 200 includes: an operation 202, transmitting, by a network node of the network system to a serving/source node and one or more target nodes of the network system, data before a handover procedure.

FIG. 3 is a flowchart illustrating a network handover enhancement method 300 by a network node according to an embodiment of the present disclosure. In some embodiments, the network handover enhancement method 300 includes: an operation 302, transmitting, by the network node to a serving/source node and one or more target nodes, data before a handover procedure.

In details, in some embodiments, the network node 10 (such as CN or GW) sends the data to the serving/source node 20 (such as Source SAT1 or Source gNB 1) and one or more target nodes (such as SAT2~Nor gNB2~N) before the handover procedure. Source SAT1 or Source gNB 1 performs the HO decision and sends the HO signaling to UE to initiate the HO procedure. This can reduce a signaling load during a HO procedure such as NTN-NTN HO procedure. There is no data forwarding during and/or after the HO procedure.

In some embodiments, the data is transmitted, by the network node 10 to the serving/source node 20 and the one or more target nodes 30, before the handover procedure instead of data forwarding during and/or after the handover (HO) procedure. That is, there is no data forwarding during and/or after HO procedure. In some embodiments, the data is further transmitted from the one or more target nodes 30 to a user equipment (UE) during and/or after the handover procedure completes. In details, during the predictability of satellite orbits, the target satellite and the following target satellites who may serve this cell can be predicable. Therefore, the network node such as a core network (CN) can deliver the data such as a user data to not only the serving/source node 20 such as the serving satellite but also the one or more target nodes 30 such as the target satellite and/or the following target satellite(s) before HO procedure initiation. In this case, there is no need to deliver the data from source cell to target cell during and/or after HO procedure. The data load can be reduced during HO procedure, and processing time of HO procedure can be further reduced.

In some embodiments, the serving/source node 20 comprises a serving/source satellite or a serving/source base station, and the one or more target nodes 30 comprises one or more target satellites or one or more target base stations. In some embodiments, the network handover enhancement method is performed in a non-terrestrial network (NTN)-based next generation-radio access network (NG-RAN) architecture. In some embodiments, the NTN-based NG-RAN architecture comprises a transparent satellite based NG-RAN architecture, a regenerative satellite based NG-RAN architecture, and/or a multi connectivity involving NTN-based NG-RAN. In some embodiments, the regenerative satellite based NG-RAN architecture comprises a gNB processed payload, a gNB-DU processed payload, and/or a gNB processed payload based on relay-like architecture.

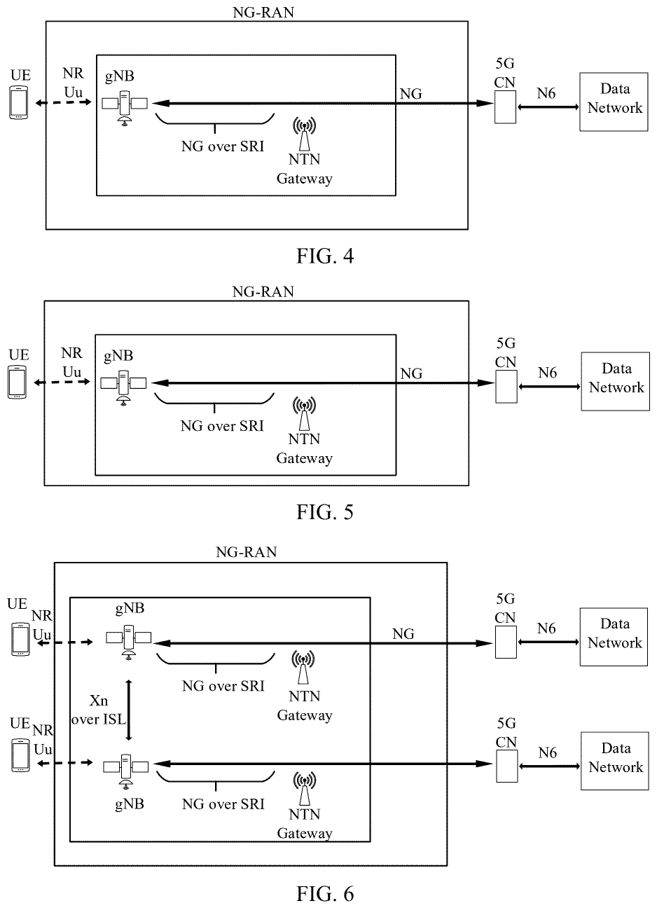

FIG. 4 is a schematic diagram illustrating a networking-RAN architecture with transparent satellite according to an embodiment of the present disclosure. A satellite (or UAS platform) which may implement a transparent payload. The satellite (or UAS platform) beams generate several beams over a given service area bounded by its field of view. The footprints of the beams are elliptic shapes. The field of view of satellites (or UAS platforms) depends on the on board antenna diagram and min elevation angle. The transparent payload refers to radio frequency filtering, frequency conversion and amplification. Hence, the waveform signal repeated by the payload is un-changed. Refer to FIG. 4, the satellite payload implements frequency conversion and a Radio Frequency amplifier in both up link and down link direction. It corresponds to an analogue RF repeater. Hence the satellite repeats the NR-Uu radio interface from the feeder link (between the NTN gateway and the satellite) to the service link (between the satellite and the UE) and vice versa. The Satellite Radio Interface (SRI) on the feeder link is the NR-Uu. In other words, the satellite does not terminate NR-Uu. The NTN gateway (GW) supports all necessary functions to forward the signal of NR-Uu interface. Different transparent satellites may be connected to the same gNB on the ground.

If the serving/source node comprises the serving/source base station, and the one or more target nodes comprises the one or more target base stations, the network handover enhancement method is performed in the transparent satellite based NG-RAN architecture.

For the networking-RAN architecture with transparent satellite, gNB is on the ground, therefore data is forwarded from source gNB to target gNB where both gNBs are on the ground. However, the NTN HO procedure might need stringent delay due to the satellite moves really fast, the UP delay caused by data forwarding during HO procedure might be an issue which can be enhanced.

For the networking-RAN architecture with transparent satellite, for DL transmission, CN can deliver data (such as user data) to the serving gNB and the target gNB and/or the following target gNB(s) before HO procedure, and there is no data forwarding during and/or after HO procedure. Target gNB can deliver user data to UE during and/or after HO completes. The benefits of the solution include the data load between ISL can be reduced during HO procedure and processing time of HO procedure can be reduced. The solution is mainly targeting the inter-gNB HO scenario.

FIG. 5 is a schematic diagram illustrating a regenerative satellite without ISL, gNB processed payload according to an embodiment of the present disclosure. A satellite (or UAS platform) which may implement a regenerative payload. The satellite (or UAS platform) beams generate several beams over a given service area bounded by its field of view. The footprints of the beams are elliptic shapes. The field of view of satellites (or UAS platforms) depends on the on board antenna diagram and min elevation angle. The regenerative payload refers to radio frequency filtering, frequency conversion and amplification as well as demodulation/decoding, switch and/or routing, coding/modulation. This is effectively equivalent to having all or part of base station functions (e.g., gNB) on board the satellite (or UAS platform). Inter-satellite links (ISL) is optionally in case of a constellation of satellites. This may require regenerative payloads on board the satellites.

If the serving/source node comprises the serving/source satellite, and the one or more target nodes comprises the one or more target satellites, the network handover enhancement method is performed in the regenerative satellite based NG-RAN architecture with the gNB processed payload, and the regenerative satellite based NG-RAN architecture comprises a regenerative satellite without an inter satellite link (ISL).

For regenerative satellite without ISL, gNB processed payload, due to without ISL, the route for date forwarding from source satellite to target satellite may be that data (such as user data) is forwarded from source satellite to source GW, to source gNB, to CN, to target gNB, to target GW, and then to target satellite. This may bring tremendous load for all the interfaces including feeder link, SRI and NG interface.

For DL transmission, CN can deliver user data to the serving satellite and target satellite and/or the following target satellite(s) before HO procedure, and there is no data forwarding during and/or after HO procedure. Target satellite can deliver user data to the UE during and/or after the HO procedure completes. During the predictability of satellite orbits, what is the target satellite and the following target satellites who may serve this cell can be predicable. Therefore, CN can deliver the user data to not only serving satellite but also the target satellite and/or the following target satellite(s) before HO procedure initiation. In this case there is no need to deliver data from source cell to target cell during and/or after the HO procedure.

FIG. 6 is a schematic diagram illustrating a regenerative satellite with ISL, gNB processed payload according to an embodiment of the present disclosure. Inter-satellite links (ISL) is optionally in case of a constellation of satellites. This may require regenerative payloads on board the satellites. ISL may operate in RF frequency or optical bands. The satellite payload also provides inter-satellite links (ISL) between satellites ISL (Inter-Satellite Links) is a transport link between satellites. ISL may be a radio interface or an optical interface. The NTN GW is a transport network layer node and supports all necessary transport protocols. FIG. 6 illustrates that a UE served by a gNB on board a satellite could access the 5GCN via ISL. The gNB on board different satellites may be connected to the same 5GCN on the ground. If the satellite hosts more than one gNB, the same SRI may transport all the corresponding NG interface instances.

If the serving/source node comprises the serving/source satellite, and the one or more target nodes comprises the one or more target satellites, the network handover enhancement method is performed in the regenerative satellite based NG-RAN architecture with the gNB processed payload, and the regenerative satellite based NG-RAN architecture comprises a regenerative satellite with an inter satellite link (ISL).

For regenerative satellite with ISL, gNB processed payload, data is forwarded from source satellite directly to target satellite via ISL. Besides the delay issue, this may also bring significant data load to ISL.

For DL transmission, CN can deliver data (such as user data) to the serving satellite and target satellite and/or the following target satellite(s) before HO procedure, and there is no data forwarding during and/or after the HO procedure. Target satellite can deliver user data to the UE during and/or after the HO procedure completes. During the predictability of satellite orbits, what is the target satellite and the following target satellites who may serve this cell can be predicable. Therefore, CN can deliver the user data to not only serving satellite but also the target satellite and/or the following target satellite(s) before HO procedure initiation. In this case there is no need to deliver data from source cell to target cell during and/or after the HO procedure.

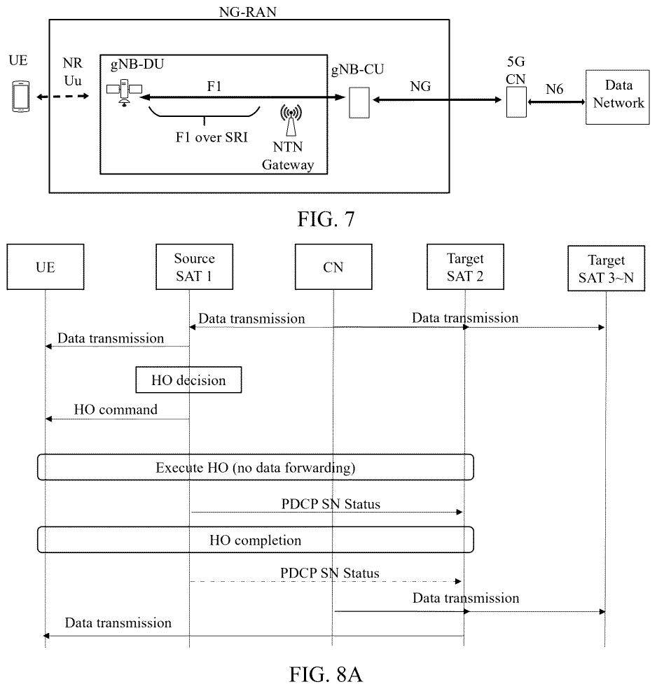

FIG. 7 is a schematic diagram illustrating a NG-RAN with a regenerative satellite based on gNB-DU according to an embodiment of the present disclosure. The NG-RAN logical architecture with CU/DU split is used as baseline for NTN scenarios. The satellite payload implements regeneration of the signals received from Earth. NR-Uu radio interface on the service link is between the satellite and the UE. Satellite radio interface (SRI) on the feeder link is between the NTN gateway and the satellite. The SRI transports the F1 protocol. The satellite payload may provide inter-satellite links between satellites. SRI (satellite radio interface) are transport links, and the logical interface F1 that they transport are 3GPP-specified. The NTN GW is a transport network layer node and supports all necessary transport protocols. DU on board different satellites may be connected to the same CU on ground. If the satellite hosts more than one DU, the same SRI may transport all the corresponding F1 interface instances.

If the serving/source node comprises the serving/source base station, and the one or more target nodes comprises the one or more target base stations, the network handover enhancement method is performed in the regenerative satellite based NG-RAN architecture with the gNB-DU processed payload.

For NG-RAN with a regenerative satellite based on gNB-DU, due to PDCP is on the ground, process of data forwarding for this architecture (NG-RAN with a regenerative satellite based on gNB-DU) is the same with or similar to the above architecture (the networking-RAN architecture with transparent satellite).

For NG-RAN with a regenerative satellite based on gNB-DU, for DL transmission, CN can deliver data (such as user data) to the serving gNB and target gNB and/or the following target gNB(s) before HO procedure, and there is no data forwarding during and/or after the HO procedure. Target gNB can deliver user data to UE during and/or after the HO procedure completes. The benefits of the solution include the data load between ISL can be reduced during HO procedure and processing time of HO procedure can be reduced.

The differences between the solution for the networking-RAN architecture with transparent satellite and NG-RAN with a regenerative satellite based on gNB-DU and the solution for the regenerative satellite with ISL, gNB processed payload and the regenerative satellite without ISL, gNB processed payload include at least one of the followings. The solution is mainly targeting the inter-gNB HO scenario.

In a current art, if a legacy HO is used, the data forwarding of gNB processed payload and the regenerative satellite with or without ISL which is the usual case for regenerative satellite may occur between satellites. In some embodiments, by using the solution of gNB processed payload and the regenerative satellite without ISL, there may be no more data forwarding between satellites. For both legacy HO or this solution of the networking-RAN architecture with transparent satellite and NG-RAN with a regenerative satellite based on gNB-DU, the data forwarding of the networking-RAN architecture with transparent satellite and NG-RAN with a regenerative satellite based on gNB-DU may occur on the ground.

The benefits of the solution of gNB processed payload and the regenerative satellite with or without ISL include that the data load can be reduced during HO procedure and processing time of HO procedure can be further reduced. The benefit of the solution of the networking-RAN architecture with transparent satellite and NG-RAN with a regenerative satellite based on gNB-DU include that the data load between ISL can be reduced during HO procedure and processing time of HO procedure can be further reduced.

In some embodiments, a number of target satellites, which data (such as the user data) is delivered to by CN before the HO procedure can be specified or based on network (NW) implementation. In details, the CN delivers the user data to the number of target satellites before the HO procedure, and the number of target satellites is specified or based on the NW implementation.

In some embodiments, the handover procedure comprises a normal handover or a conditional handover. In details, in some examples, the normal handover may be a legacy normal handover. In some examples, the conditional handover may be a legacy conditional handover.

In some embodiments, transmitting, by the network node to the serving/source node and the one or more target nodes, the data before the handover procedure further comprises:
transmitting, by the network node to the serving/source node and the one or more target nodes, the data before a handover decision;
transmitting, by the network node to the serving/source node and the one or more target nodes, the data before the handover decision and after a handover preparation; or
transmitting, by the network node to the serving/source node and the one or more target nodes, the data before the handover decision, after the handover preparation, and after the serving/source node transmitting an indication to the network node.

In some embodiments, the network node comprises a core network (CN) or a gateway (GW). Due to different satellites can connect to the same GW, CN can deliver to GW first, and GW can store and deliver the user data to target satellite to further reduce the processing time. Therefore, there may have two options (CN or GW) to perform the user data delivery to target satellite(s). In some examples, the gateway (GW) is especially under the scenario where different satellites are connected to the same GW. This embodiment is for example applicable to the regenerative satellite based NG-RAN architecture with the gNB processed payload, and the regenerative satellite based NG-RAN architecture comprises a regenerative satellite with an inter satellite link (ISL) or the regenerative satellite without the ISL.

In some embodiments, the network handover enhancement method further comprises determining if a packet status is transmitted from the serving/source node to the one or more target nodes. Packet status can refer to transmitting and/or receiving status of the packet. Specifically, for example, the packet status indicates which packet(s) can be received correctly and which packet(s) is lost. In details, in some examples, the packet status comprises a packet data convergence protocol (PDCP) sequence number (SN) status.

In some examples, if PDCP SN status is needed to be delivered from source satellite to target satellites, in this case target satellite is aware of what is the next packet (PDCP PDU) needed to be delivered to UE according to the received PDCP status report.

In some examples, if there is no need to deliver PDCP SN status from source satellite to target satellites, in this case the target satellite transmits the next packet without PDCP status report, e.g., leave it to NW implementation, and the UE can do the duplication detect and discard on its own, e.g., leave to UE implementation.

Solutions for the regenerative satellite with ISL, gNB processed payload and the regenerative satellite without ISL, gNB processed payload can refer to the following embodiments 1 to 24. Further, solutions for the networking-RAN architecture with transparent satellite and NG-RAN with a regenerative satellite based on gNB-DU can also refer to the following embodiments 1 to 24 if the entity is replaced from satellite to gNB.

### Embodiment 1

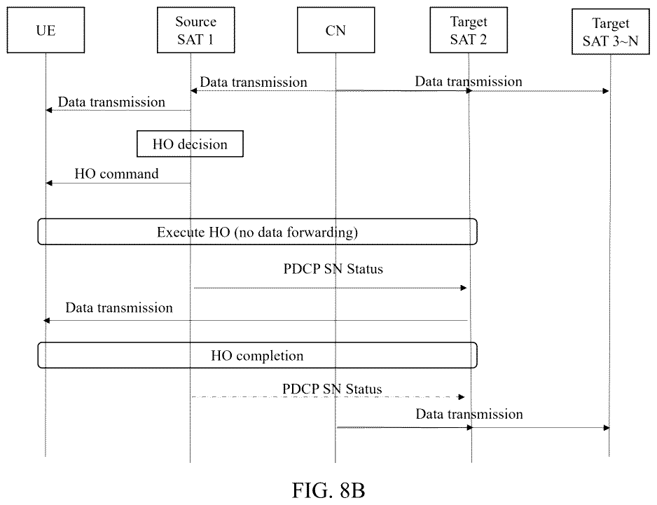

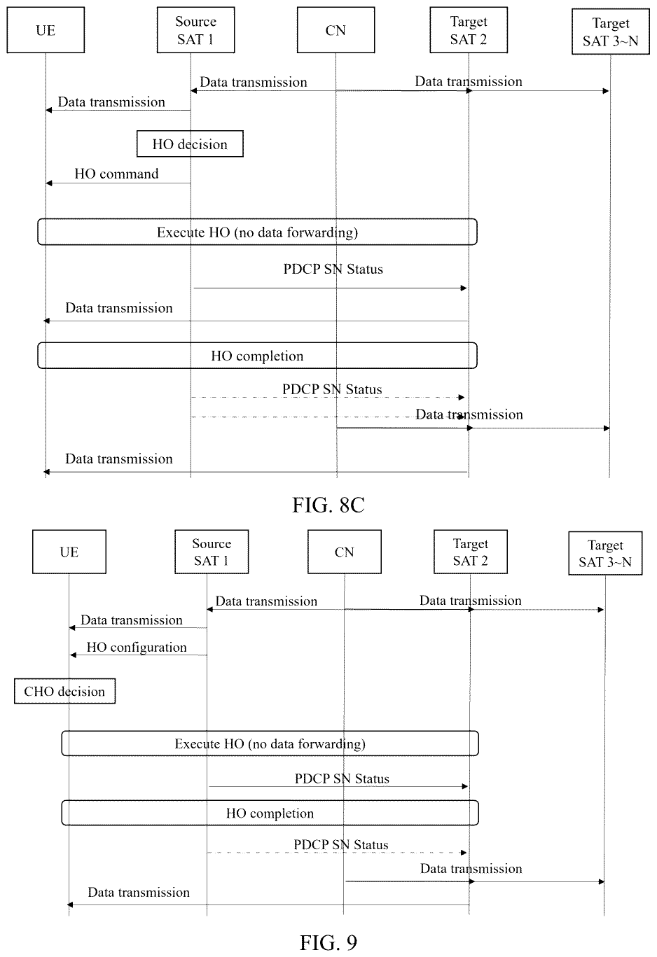

FIG. 8A, FIG. 8B, and FIG. 8C illustrate that, in some embodiments, the handover procedure comprises the normal handover, the data is transmitted from the network node to the serving/source node and the one or more target nodes before the handover decision, the network node comprises the CN, and the packet status is transmitted from the serving/source node to the one or more target nodes.

Source SAT1(SAT1 for short): Serving cell satellite. Target SAT2 (SAT2 for short): Satellite of next serving cell. Target 3~N (SAT3~N for short): Satellites of next serving cell after SAT2.

FIG. 8A, FIG. 8B, and FIG. 8C illustrate that, in some embodiments, CN sends the data (such as a user data) to SAT1~N. Source SAT1 performs the HO decision and sends the HO signaling to UE to initiate the HO procedure. PDCP CN status can be delivered during the HO procedure and/or after the HO procedure completes, from SAT1 to SAT2. CN sends the data to SAT2~N during and/or after HO procedure completes. SAT2 starts to serve the UEs in the cell. This can reduce a signaling load during a HO procedure such as NTN-NTN HO procedure. There is no data forwarding during and/or after HO procedure.

FIG. 8A, FIG. 8B, and FIG. 8C illustrate that, in some examples, in a general operation, the network node such as the CN transmits data to SAT2 and/or SAT3~N after HO completion (i.e., the handover procedure completes). FIG. 8A illustrates that, in some examples, SAT2 transmits the data to the UE after HO completion (i.e., the handover procedure completes). FIG. 8B illustrates that, in some examples, SAT2 transmits the data to the UE during HO completion (i.e., the handover procedure completes). FIG. 8C illustrates that, in some examples, SAT2 transmits the data to the UE during and after HO completion (i.e., the handover procedure completes). FIG. 9 to FIG. 22 of the following embodiments are all applicable to or similar to the examples of FIG. 8A, FIG. 8B and FIG. 8C. That is, in some examples, in a general operation, the network node (such as CN or GW) transmits data to target node (such as gNB2 or SAT2) and/or target node(s) (such as gNB3~N or SAT3~N) after HO completion (i.e., the handover procedure completes). In some examples, the target node (such as gNB2 or SAT2) transmits the data to the UE during and/or after HO completion (i.e., the handover procedure completes). Therefore, the following FIG. 9 to FIG. 22 will not be drawn and described one by one.

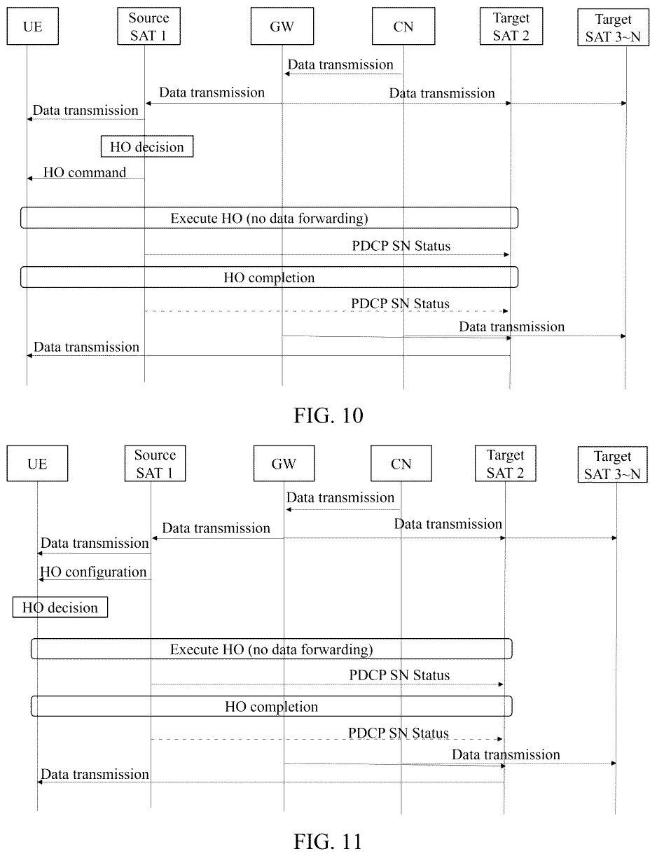

FIG. 8A to FIG. 11 illustrate that, some embodiments of HO decision. FIG. 8A, FIG. 8B, and FIG. 8C illustrate that, in some embodiments, the network system includes UE, Source SAT 1, CN, Target SAT 2, and Target SAT 3~N, wherein Source SAT 1 performs the HO decision. FIG. 9 illustrates that, in some embodiments, the network system includes UE, Source SAT 1, CN, Target SAT 2, and Target SAT 3~N, wherein UE performs the CHO decision. FIG. 10 illustrates that, in some embodiments, the network system includes UE, Source SAT 1, CN, GW, Target SAT 2, and Target SAT 3~N, wherein Source SAT 1 performs the HO decision. FIG. 11 illustrates that, in some embodiments, the network system includes UE, Source SAT 1, CN, GW, Target SAT 2, and Target SAT 3~N, wherein UE performs the HO decision.

### Embodiment 2

The handover procedure comprises the normal handover, the data is transmitted from the network node to the serving/source node and the one or more target nodes before the handover decision, the network node comprises the CN, and none of the packet status is transmitted from the serving/source node to the one or more target nodes. This can reduce a signaling load during a HO procedure such as NTN-NTN HO procedure. There is no data forwarding during and/or after HO procedure.

There is no need to deliver the PDCP SN status report from source satellite to target satellite. In this case the target satellite transmits the next packet without PDCP Status report, e.g., leave it to NW implementation, and the UE can do the duplication detect and discard on its own, e.g., leave it to UE implementation. All the other steps or operations are the same or similar to the above embodiments such as the embodiment 1.

### Embodiment 3

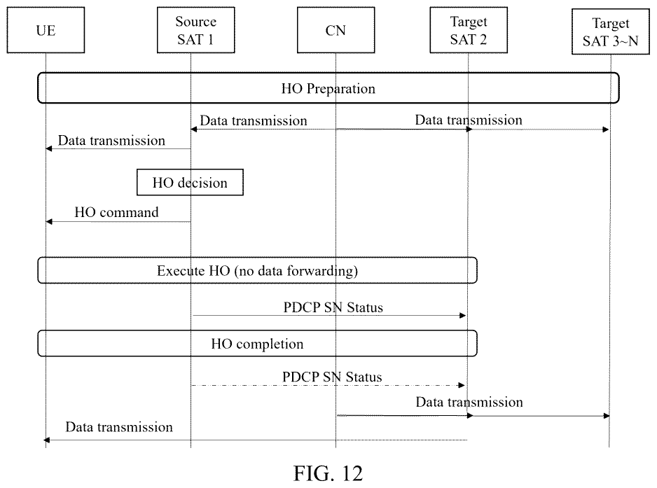

FIG. 12 illustrates that, in some embodiments, the handover procedure comprises the normal handover, the data is transmitted from the network node to the serving/source node and the one or more target nodes before the handover decision and after the handover preparation, the network node comprises the CN, and the packet status is transmitted from the serving/source node to the one or more target nodes. This can reduce a signaling load during a HO procedure such as NTN-NTN HO procedure. There is no data forwarding during and/or after the HO procedure.

The difference between the embodiment 3 and the embodiment 1 is that the data transmission timing is specified. The timing is right after the HO preparation completion. FIG. 12 illustrates that, in some embodiments, the HO phases of legacy normal HO and the one in the square is the HO preparation phase. All the other steps or operations are the same or similar to the above embodiments.

### Embodiment 4

The handover procedure comprises the normal handover, the data is transmitted from the network node to the serving/source node and the one or more target nodes before the handover decision and after the handover preparation, the network node comprises the CN, and none of the packet status is transmitted from the serving/source node to the one or more target nodes. This can reduce a signaling load during a HO procedure such as NTN-NTN HO procedure. There is no data forwarding during and/or after the HO procedure.

There is no need to deliver the PDCP SN Status report from Source satellite to target satellite. In this case the target satellite transmits the next packet without PDCP Status report, e.g., leave it to NW implementation, and the UE can do the duplication detect and discard on its own, e.g., leave it to UE implementation. All the other steps or operations are the same or similar to the above embodiments.

### Embodiment 5

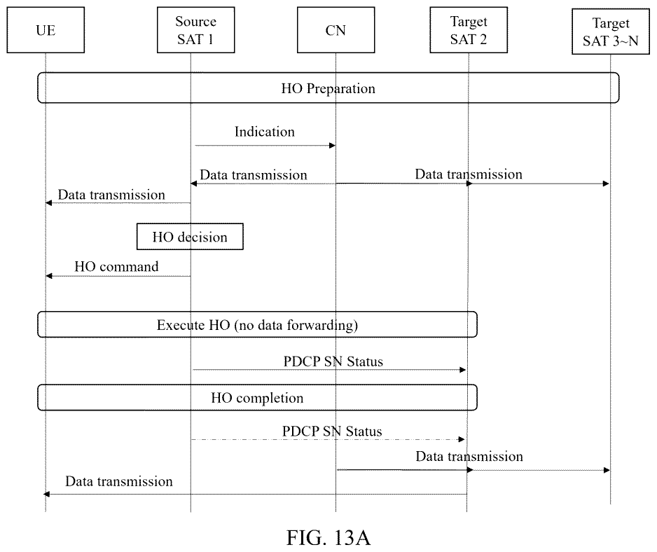

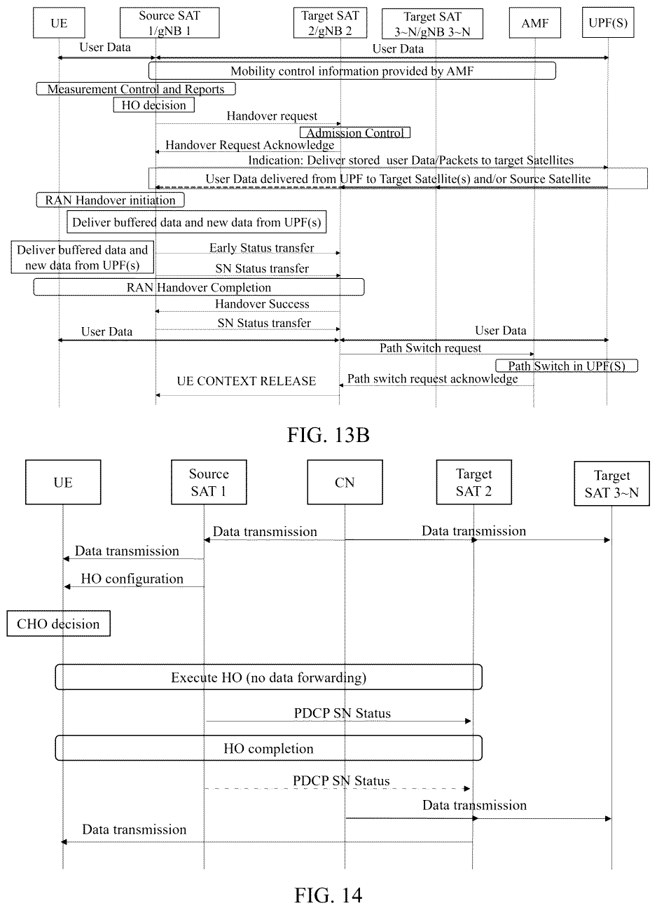

FIG. 13A illustrates that, in some embodiments, the handover procedure comprises the normal handover, the data is transmitted from the network node to the serving/source node and the one or more target nodes before the handover decision, after the handover preparation, and after the serving/source node transmitting an indication to the network node, the network node comprises the CN, and the packet status is transmitted from the serving/source node to the one or more target nodes. This can reduce a signaling load during a HO procedure such as NTN-NTN HO procedure. There is no data forwarding during and/or after HO procedure.

The difference between the embodiment 5 and the embodiments 1 and 2 is that the data transmission timing is after the HO preparation completion and wait until the source satellite sends the indication to CN. All the other steps or operations are the same or similar to the above embodiments.

More specifically, FIG. 13B illustrates that, an example of the detailed HO procedure is given as the following.

The steps or operations include the followings.
0. The UE context within the source gNB contains information regarding roaming and access restrictions which were provided either at connection establishment or at the last TA update.
1. The source gNB configures the UE measurement procedures and the UE reports according to the measurement configuration.
2. The source gNB decides to handover the UE, based on MeasurementReport and RRM information.
3. The source gNB issues a Handover Request message to the target gNB passing a transparent RRC container with necessary information to prepare the handover at the target side. The information includes at least the target cell ID, KgNB*, the C-RNTI of the UE in the source gNB, RRM-configuration including UE inactive time, basic AS-configuration including antenna Info and DL Carrier Frequency, the current QoS flow to DRB mapping rules applied to the UE, the SIB1 from source gNB, the UE capabilities for different RATs, PDU session related information, and can include the UE reported measurement information including beam-related information if available. The PDU session related information includes the slice information and QoS flow level QoS profile(s). The source gNB may also request a DAPS handover for one or more DRBs.
NOTE 1: After issuing a Handover Request, the source gNB should not reconfigure the UE, including performing Reflective QoS flow to DRB mapping.

Admission Control may be performed by the target gNB. Slice-aware admission control shall be performed if the slice information is sent to the target gNB. If the PDU sessions are associated with non-supported slices the target gNB shall reject such PDU Sessions.

The target gNB prepares the handover with L1/L2 and sends the HANDOVER REQUEST ACKNOWLEDGE to the source gNB, which includes a transparent container to be sent to the UE as an RRC message to perform the handover. The target gNB also indicates if a DAPS handover is accepted.
NOTE 2: As soon as the source gNB receives the HANDOVER REQUEST ACKNOWLEDGE, or as soon as the transmission of the handover command is initiated in the downlink, data forwarding may be initiated.
NOTE 3: For DRBs configured with DAPS, downlink PDCP SDUs are forwarded with SN assigned by the source gNB, until SN assignment is handed over to the target gNB in step 8b, for which the normal data forwarding.
Added step 1a: Source Satellite/gNB sends an indication regarding the data delivery form UPF to target Satellite(s)/gNB(s) via NGAP message to AMF, and then AMF deliver the indication to UPF.
Added step 1b: Source Satellite/gNB sends an indication to UPF regarding the data delivery form UPF to target Satellite(s)/gNB(s).
Added step 2: UPF deliver user data to target Satellite(s)/gNB(s).
6. The source gNB triggers the Uu handover by sending an RRCReconfiguration message to the UE, containing the information required to access the target cell: at least the target cell ID, the new C-RNTI, the target gNB security algorithm identifiers for the selected security algorithms. It can also include a set of dedicated RACH resources, the association between RACH resources and SSB(s), the association between RACH resources and UE-specific CSI-RS configuration(s), common RACH resources, and system information of the target cell, etc.
NOTE 4: For DRBs configured with DAPS, the source gNB does not stop transmitting downlink packets until it receives the HANDOVER SUCCESS message from the target gNB in step 8a.
NOTE 4a: CHO cannot be configured simultaneously with DAPS handover.
7a. For DRBs configured with DAPS, the source gNB sends the EARLY STATUS TRANSFER message. The DL COUNT value conveyed in the EARLY STATUS TRANSFER message indicates PDCP SN and HFN of the first PDCP SDU that the source gNB forwards to the target gNB. The source gNB does not stop assigning SNs to downlink PDCP SDUs until it sends the SN STATUS TRANSFER message to the target gNB in step 8b.
7. For DRBs not configured with DAPS, the source gNB sends the SN STATUS TRANSFER message to the target gNB to convey the uplink PDCP SN receiver status and the downlink PDCP SN transmitter status of DRBs for which PDCP status preservation applies (i.e., for RLC AM). The uplink PDCP SN receiver status includes at least the PDCP SN of the first missing UL PDCP SDU and may include a bit map of the receive status of the out of sequence UL PDCP SDUs that the UE needs to retransmit in the target cell, if any. The downlink PDCP SN transmitter status indicates the next PDCP SN that the target gNB shall assign to new PDCP SDUs, not having a PDCP SN yet.
NOTE 5: In case of DAPS handover, the uplink PDCP SN receiver status and the downlink PDCP SN transmitter status for a DRB with RLC-AM and not configured with DAPS may be transferred by the SN STATUS TRANSFER message in step 8b instead of step 7.
NOTE 6: For DRBs configured with DAPS, the source gNB may additionally send the EARLY STATUS TRANSFER message(s) between step 7 and step 8b, to inform discarding of already forwarded PDCP SDUs. The target gNB does not transmit forwarded downlink PDCP SDUs to the UE, whose COUNT is less than the conveyed DL COUNT value and discards them if transmission has not been attempted already.
8. The UE synchronizes to the target cell and completes the RRC handover procedure by sending RRCReconfigurationComplete message to target gNB. In case of DAPS handover, the UE does not detach from the source cell upon receiving the RRCReconfiguration message. The UE releases the source resources and configurations and stops DL/UL reception/transmission with the source upon receiving an explicit release from the target node.
NOTE 6a: From RAN point of view, the DAPS handover is considered to only be completed after the UE has released the source cell as explicitly requested from the target node. RRC suspend, a subsequent handover or inter-RAT handover cannot be initiated until the source cell has been released.
NOTE 7: The uplink PDCP SN receiver status and the downlink PDCP SN transmitter status are also conveyed for DRBs with RLC-UM in the SN STATUS TRANSFER message in step 8b, if configured with DAPS.
NOTE 8: For DRBs configured with DAPS, the source gNB does not stop delivering uplink QoS flows to the UPF until it sends the SN STATUS TRANSFER message in step 8b. The target gNB does not forward QoS flows of the uplink PDCP SDUs successfully received in-sequence to the UPF until it receives the SN STATUS TRANSFER message, in which UL HFN and the first missing SN in the uplink PDCP SN receiver status indicates the start of uplink PDCP SDUs to be delivered to the UPF. The target gNB does not deliver any uplink PDCP SDUs which has an UL COUNT lower than the provided.
NOTE 9: Void.
9. The target gNB sends a PATH SWITCH REQUEST message to AMF to trigger 5GC to switch the DL data path towards the target gNB and to establish an NG-C interface instance towards the target gNB.
10. 5GC switches the DL data path towards the target gNB. The UPF sends one or more “end marker” packets on the old path to the source gNB per PDU session/tunnel and then can release any U-plane/TNL resources towards the source gNB.
11. The AMF confirms the PATH SWITCH REQUEST message with the PATH SWITCH REQUEST ACKNOWLEDGE message.

The RRM configuration can include both beam measurement information (for layer 3 mobility) associated to SSB(s) and CSI-RS(s) for the reported cell(s) if both types of measurements are available. Also, if CA is configured, the RRM configuration can include the list of best cells on each frequency for which measurement information is available. And the RRM measurement information can also include the beam measurement for the listed cells that belong to the target gNB.

The common RACH configuration for beams in the target cell is only associated to the SSB(s). The network can have dedicated RACH configurations associated to the SSB(s) and/or have dedicated RACH configurations associated to CSI-RS(s) within a cell. The target gNB can only include one of the following RACH configurations in the Handover Command to enable the UE to access the target cell:
i) Common RACH configuration;
ii) Common RACH configuration+Dedicated RACH configuration associated with SSB;
iii) Common RACH configuration+Dedicated RACH configuration associated with CSI-RS.

The dedicated RACH configuration allocates RACH resource(s) together with a quality threshold to use them. When dedicated RACH resources are provided, they are prioritized by the UE and the UE shall not switch to contention-based RACH resources as long as the quality threshold of those dedicated resources is met. The order to access the dedicated RACH resources is up to UE implementation.

Upon receiving a handover command requesting DAPS handover, the UE suspends source cell SRBs, stops sending and receiving any RRC control plane signaling toward the source cell, and establishes SRBs for the target cell. The UE releases the source cell SRBs configuration upon receiving source cell release indication from the target cell after successful DAPS handover execution. When DAPS handover to the target cell fails and if the source cell link is available, then the UE reverts back to the source cell configuration and resumes source cell SRBs for control plane signaling transmission.

### Embodiment 6

The handover procedure comprises the normal handover, the data is transmitted from the network node to the serving/source node and the one or more target nodes before the handover decision, after the handover preparation, and after the serving/source node transmitting an indication to the network node, the network node comprises the CN, and none of the packet status is transmitted from the serving/source node to the one or more target nodes. This can reduce a signaling load during a HO procedure such as NTN-NTN HO procedure. There is no data forwarding during and/or after the HO procedure.

There is no need to deliver the PDCP SN Status report from Source satellite to target satellite. In this case the target satellite transmits the next packet without PDCP Status report, e.g., leave it to NW implementation, and the UE can do the duplication detect and discard on its own, e.g., leave it to UE implementation. All the other steps or operations are the same or similar to the above embodiments.

### Embodiment 7

FIG. 14 illustrates that, in some embodiments, the handover procedure comprises the conditional handover, the data is transmitted from the network node to the serving/source node and the one or more target nodes before the handover decision, the network node comprises the CN, and the packet status is transmitted from the serving/source node to the one or more target nodes. This can reduce a signaling load during a HO procedure such as NTN-NTN HO procedure. There is no data forwarding during and/or after the HO procedure. The difference between this embodiment and the embodiment 1 is this is a CHO procedure. All the other steps or operations are the same or similar to the above embodiments.

### Embodiment 8

The handover procedure comprises the conditional handover, the data is transmitted from the network node to the serving/source node and the one or more target nodes before the handover decision, the network node comprises the CN, and none of the packet status is transmitted from the serving/source node to the one or more target nodes. This can reduce a signaling load during a HO procedure such as NTN-NTN HO procedure. There is no data forwarding during and/or after the HO procedure.

There is no need to deliver the PDCP SN Status report from Source satellite to target satellite. In this case the target satellite transmits the next packet without PDCP Status report, e.g., leave it to NW implementation, and the UE can do the duplication detect and discard on its own, e.g., leave it to UE implementation. All the other steps or operations are the same or similar to the above embodiments.

### Embodiment 9

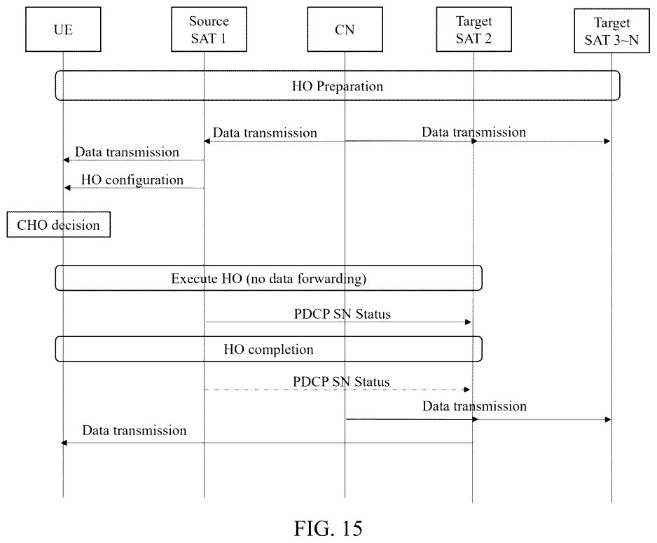

FIG. 15 illustrates that, in some embodiments, the handover procedure comprises the conditional handover, the data is transmitted from the network node to the serving/source node and the one or more target nodes before the handover decision and after the handover preparation, the network node comprises the CN, and the packet status is transmitted from the serving/source node to the one or more target nodes. This can reduce a signaling load during a HO procedure such as NTN-NTN HO procedure. There is no data forwarding during and/or after the HO procedure. The difference between the embodiment 12 and the embodiment 4 is the data transmission timing is specified. The timing is right after the HO preparation completion. All the other steps or operations are the same or similar to the above embodiments.

### Embodiment 10

The handover procedure comprises the conditional handover, the data is transmitted from the network node to the serving/source node and the one or more target nodes before the handover decision and after the handover preparation, the network node comprises the CN, and none of the packet status is transmitted from the serving/source node to the one or more target nodes. This can reduce a signaling load during a HO procedure such as NTN-NTN HO procedure. There is no data forwarding during and/or after the HO procedure.

There is no need to deliver the PDCP SN Status report from Source satellite to target satellite. In this case the target satellite transmits the next packet without PDCP Status report, e.g., leave it to NW implementation, and the UE can do the duplication detect and discard on its own, e.g., leave to UE implementation. All the other steps or operations are the same or similar to the above embodiments.

### Embodiment 11

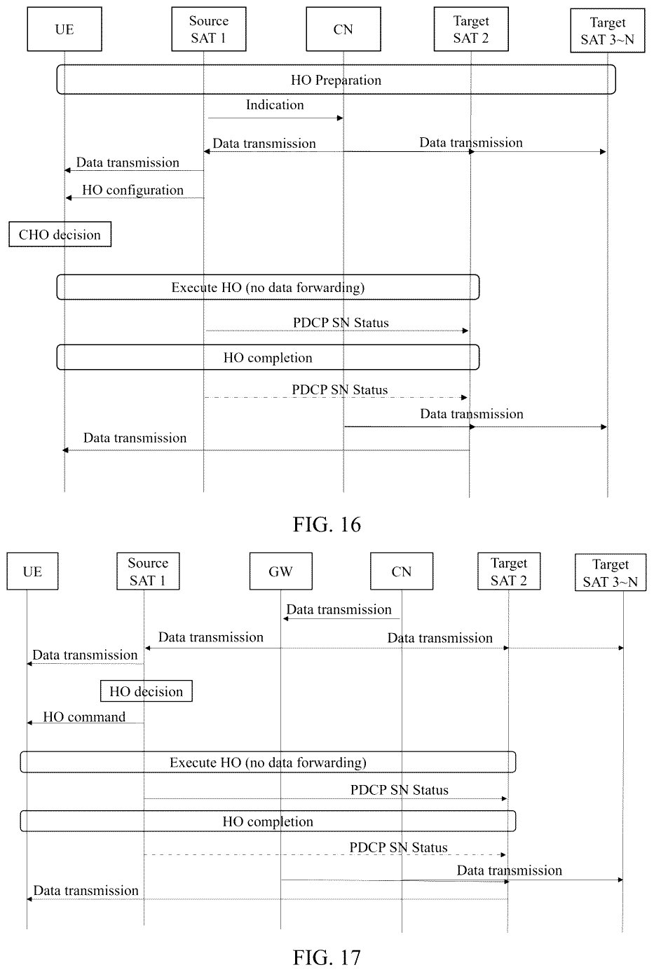

FIG. 16 illustrates that, in some embodiments, the handover procedure comprises the conditional handover, the data is transmitted from the network node to the serving/source node and the one or more target nodes before the handover decision, after the handover preparation, and after the serving/source node transmitting an indication to the network node, the network node comprises the CN, and the packet status is transmitted from the serving/source node to the one or more target nodes. This can reduce a signaling load during a HO procedure such as NTN-NTN HO procedure. There is no data forwarding during and/or after the HO procedure. The difference between this embodiment and the embodiments 4 and 5 is that the data transmission timing is after the HO preparation completion and wait until the source satellite sends the indication to CN. All the other steps or operations are the same or similar to the above embodiments.

### Embodiment 12

The handover procedure comprises the conditional handover, the data is transmitted from the network node to the serving/source node and the one or more target nodes before the handover decision, after the handover preparation, and after the serving/source node transmitting an indication to the network node, the network node comprises the CN, and none of the packet status is transmitted from the serving/source node to the one or more target nodes. This can reduce a signaling load during a HO procedure such as NTN-NTN HO procedure. There is no data forwarding during and/or after the HO procedure.

There is no need to deliver the PDCP SN Status report from Source satellite to target satellite. In this case the target satellite transmits the next packet without PDCP Status report, e.g., leave it to NW implementation, and the UE can do the duplication detect and discard on its own, e.g., leave it to UE implementation. All the other steps or operations are the same or similar to the above embodiments.

### Embodiment 13

FIG. 17 illustrates that, in some embodiments, the handover procedure comprises the normal handover, the data is transmitted from the network node to the serving/source node and the one or more target nodes before the handover decision, the network node comprises the gateway, and the packet status is transmitted from the serving/source node to the one or more target nodes. This can reduce a signaling load during a HO procedure such as NTN-NTN HO procedure. There is no data forwarding during and/or after the HO procedure.

The difference between this embodiment and the embodiment 1 is that, under the scenario where feeder link stays the same, CN can transmit the data to GW first and GW can store and send the date to target satellites. The signaling load and HO delay can be further reduced in this way.

Source SAT1: Serving cell satellite. Target SAT2: Satellite of next serving cell. Target 3~N: Satellites of next serving cell after SAT2.

FIG. 17 illustrates that, in some embodiments, The procedure could be: CN transmits the data to GW. GW sends the data to SAT1~N. Source SAT1 performs the HO decision and sends the HO signaling to UE to initiate the HO procedure. PDCP CN Status can be delivered during the HO procedure and/or after the HO procedure completes, from SAT1 to SAT2. GW sends the data to SAT2~N after during and/or after the HO procedure completes. SAT2 starts to serve the UEs in the cell.

### Embodiment 14

The handover procedure comprises the normal handover, the data is transmitted from the network node to the serving/source node and the one or more target nodes before the handover decision, the network node comprises the gateway, and none of the packet status is transmitted from the serving/source node to the one or more target nodes. This can reduce a signaling load during a HO procedure such as NTN-NTN HO procedure. There is no data forwarding during and/or after the HO procedure.

There is no need to deliver the PDCP SN Status report from Source satellite to target satellite. In this case the target satellite transmits the next packet without PDCP Status report, e.g., leave it to NW implementation, and the UE can do the duplication detect and discard on its own, e.g., leave it to UE implementation. All the other steps or operations are the same or similar to the above embodiments.

### Embodiment 15

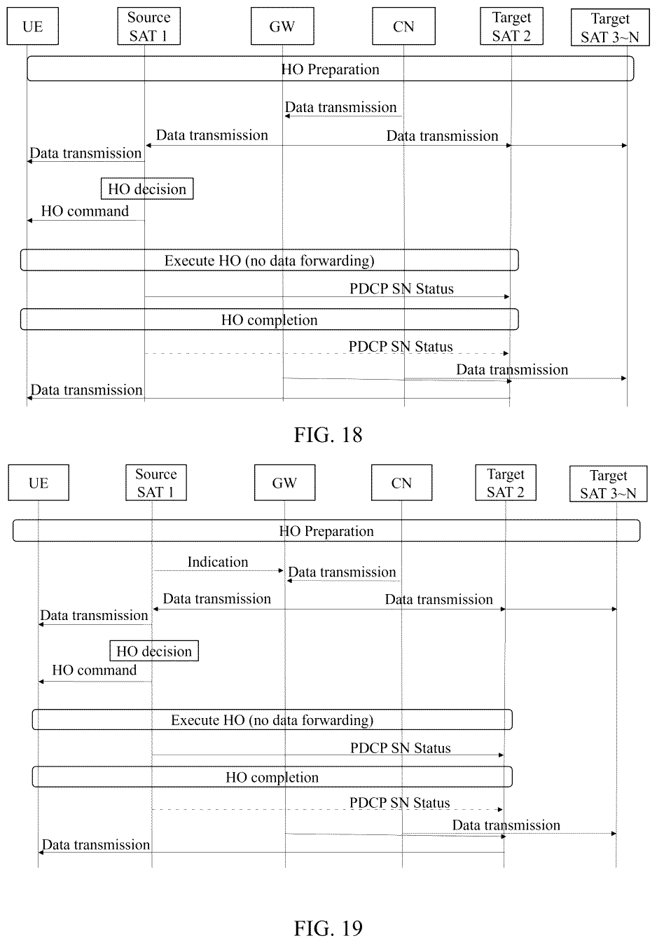

FIG. 18 illustrates that, in some embodiments, the handover procedure comprises the normal handover, the data is transmitted from the network node to the serving/source node and the one or more target nodes before the handover decision and after the handover preparation, the network node comprises the gateway, and the packet status is transmitted from the serving/source node to the one or more target nodes. This can reduce a signaling load during a HO procedure such as NTN-NTN HO procedure. There is no data forwarding during and/or after the HO procedure. The difference between this embodiment and the embodiment 7 is the data transmission timing is specified. The timing is right after the HO preparation completion. All the other steps or operations are the same or similar to the above embodiments.

### Embodiment 16

The handover procedure comprises the normal handover, the data is transmitted from the network node to the serving/source node and the one or more target nodes before the handover decision and after the handover preparation, the network node comprises the gateway, and none of the packet status is transmitted from the serving/source node to the one or more target nodes. This can reduce a signaling load during a HO procedure such as NTN-NTN HO procedure. There is no data forwarding during and/or after the HO procedure.

There is no need to deliver the PDCP SN Status report from Source satellite to target satellite. In this case the target satellite transmits the next packet without PDCP Status report, e.g., leave it to NW implementation, and the UE can do the duplication detect and discard on its own, e.g., leave it to UE implementation. All the other steps or operations are the same or similar to the above embodiments.

### Embodiment 17

FIG. 19 illustrates that, in some embodiments, the handover procedure comprises the normal handover, the data is transmitted from the network node to the serving/source node and the one or more target nodes before the handover decision, after the handover preparation, and after the serving/source node transmitting an indication to the network node, the network node comprises the gateway, and the packet status is transmitted from the serving/source node to the one or more target nodes. This can reduce a signaling load during a HO procedure such as NTN-NTN HO procedure. There is no data forwarding during and/or after the HO procedure. The difference between this embodiment and the embodiment 7 and 8 is the data transmission timing is after the HO preparation completion and wait until the source satellite sends the indication to CN. All the other steps or operations are the same or similar to the above embodiments.

### Embodiment 18

The handover procedure comprises the normal handover, the data is transmitted from the network node to the serving/source node and the one or more target nodes before the handover decision, after the handover preparation, and after the serving/source node transmitting an indication to the network node, the network node comprises the gateway, and none of the packet status is transmitted from the serving/source node to the one or more target nodes. This can reduce a signaling load during a HO procedure such as NTN-NTN HO procedure.

There is no need to deliver the PDCP SN Status report from Source satellite to target satellite. In this case the target satellite transmits the next packet without PDCP Status report, e.g., leave it to NW implementation, and the UE can do the duplication detect and discard on its own, e.g., leave it to UE implementation. no data forwarding during and/or after the HO procedure. All the other steps or operations are the same or similar to the above embodiments.

### Embodiment 19

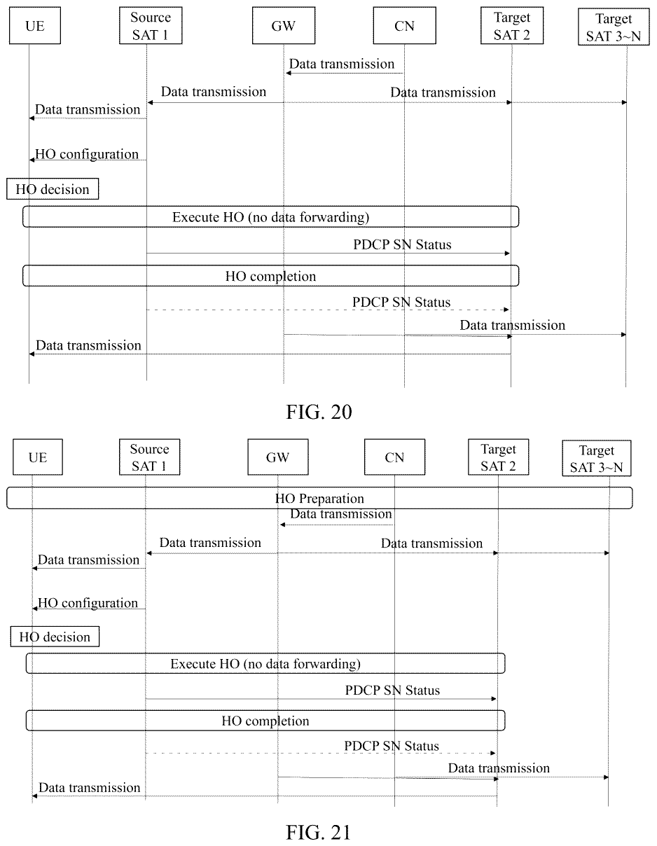

FIG. 20 illustrates that, in some embodiments, the handover procedure comprises the conditional handover, the data is transmitted from the network node to the serving/source node and the one or more target nodes before the handover decision, the network node comprises the gateway, and the packet status is transmitted from the serving/source node to the one or more target nodes. This can reduce a signaling load during a HO procedure such as NTN-NTN HO procedure. There is no data forwarding during and/or after the HO procedure. The difference between this embodiment and the embodiment 7 is this is a CHO procedure. All the other steps or operations are the same or similar to the above embodiments.

### Embodiment 20

The handover procedure comprises the conditional handover, the data is transmitted from the network node to the serving/source node and the one or more target nodes before the handover decision, the network node comprises the gateway, and none of the packet status is transmitted from the serving/source node to the one or more target nodes. This can reduce a signaling load during a HO procedure such as NTN-NTN HO procedure. There is no data forwarding during and/or after the HO procedure.

There is no need to deliver the PDCP SN Status report from Source satellite to target satellite. In this case the target satellite transmits the next packet without PDCP Status report, e.g., leave it to NW implementation, and the UE can do the duplication detect and discard on its own, e.g., leave it to UE implementation. All the other steps or operations are the same or similar to the above embodiments.

### Embodiment 21

FIG. 21 illustrates that, in some embodiments, the handover procedure comprises the conditional handover, the data is transmitted from the network node to the serving/source node and the one or more target nodes before the handover decision and after the handover preparation, the network node comprises the gateway, and the packet status is transmitted from the serving/source node to the one or more target nodes. This can reduce a signaling load during a HO procedure such as NTN-NTN HO procedure. There is no data forwarding during and/or after the HO procedure. The difference between this embodiment and the embodiment 10 is the data transmission timing is specified. The timing is right after the HO preparation completion. All the other steps or operations are the same or similar to the above embodiments.

### Embodiment 22

The handover procedure comprises the conditional handover, the data is transmitted from the network node to the serving/source node and the one or more target nodes before the handover decision and after the handover preparation, the network node comprises the gateway, and none of the packet status is transmitted from the serving/source node to the one or more target nodes. This can reduce a signaling load during a HO procedure such as NTN-NTN HO procedure. There is no data forwarding during and/or after the HO procedure.

There is no need to deliver the PDCP SN Status report from Source satellite to target satellite. In this case the target satellite transmits the next packet without PDCP Status report, e.g., leave it to NW implementation, and the UE can do the duplication detect and discard on its own, e.g., leave it to UE implementation. All the other steps or operations are the same or similar to the above embodiments.

### Embodiment 23

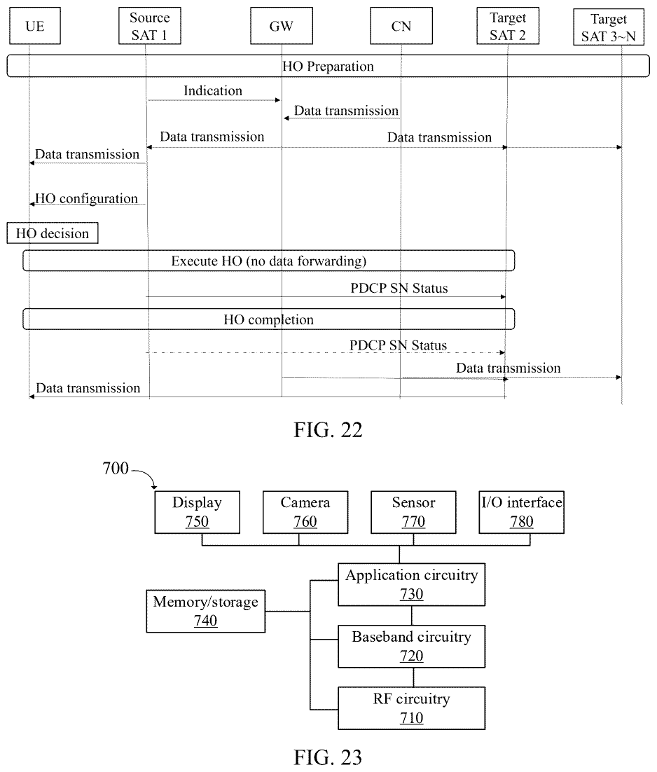

FIG. 22 illustrates that, in some embodiments, the handover procedure comprises the conditional handover, the data is transmitted from the network node to the serving/source node and the one or more target nodes before the handover decision, after the handover preparation, and after the serving/source node transmitting an indication to the network node, the network node comprises the gateway, and the packet status is transmitted from the serving/source node to the one or more target nodes. This can reduce a signaling load during a HO procedure such as NTN-NTN HO procedure. There is no data forwarding during and/or after the HO procedure. The difference between this embodiment and the embodiment 11 and 12 is the data transmission timing is after the HO preparation completion and wait until the UE sends the indication to the source satellite. All the other steps or operations are the same or similar to the above embodiments.

### Embodiment 24

The handover procedure comprises the conditional handover, the data is transmitted from the network node to the serving/source node and the one or more target nodes before the handover decision, after the handover preparation, and after the serving/source node transmitting an indication to the network node, the network node comprises the gateway, and none of the packet status is transmitted from the serving/source node to the one or more target nodes. This can reduce a signaling load during a HO procedure such as NTN-NTN HO procedure. There is no data forwarding during and/or after the HO procedure.

There is no need to deliver the PDCP SN Status report from Source satellite to target satellite. In this case the target satellite transmits the next packet without PDCP Status report, e.g., leave it to NW implementation, and the UE can do the duplication detect and discard on its own, e.g., leave it to UE implementation. All the other steps or operations are the same or similar to the above embodiments.

FIG. 23 is a block diagram of an example system 700 for wireless communication according to an embodiment of the present disclosure. Embodiments described herein may be implemented into the system using any suitably configured hardware and/or software. FIG. 23 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A network handover enhancement method by a network system, comprising:
transmitting, by a network node of the network system to a serving/source node and one or more target nodes of the network system, data before a handover procedure.

2. The network handover enhancement method according to claim 1, wherein the data is transmitted, by the network node to the serving/source node and the one or more target nodes, before the handover procedure instead of data forwarding during and/or after the handover procedure.

3. The network handover enhancement method according to claim 1, wherein the data is further transmitted from the one or more target nodes to a user equipment (UE) during and/or after the handover procedure completes.

4. The network handover enhancement method according to any claim 1, wherein the serving/source node comprises a serving/source satellite or a serving/source base station, and the one or more target nodes comprises one or more target satellites or one or more target base stations.

5. The network handover enhancement method according to claim 1, wherein the network handover enhancement method is performed in a non-terrestrial network (NTN)-based next generation-radio access network (NG-RAN) architecture.

6. The network handover enhancement method according to claim 5, wherein the NTN-based NG-RAN architecture comprises a transparent satellite based NG-RAN architecture, a regenerative satellite based NG-RAN architecture, and/or a multi connectivity involving NTN-based NG-RAN.

7. The network handover enhancement method according to claim 6, wherein the regenerative satellite based NG-RAN architecture comprises a gNB processed payload, a gNB-DU processed payload, and/or a gNB processed payload based on relay-like architecture.

8. The network handover enhancement method according to claim 6, wherein if the serving/source node comprises the serving/source satellite, and the one or more target nodes comprises the one or more target satellites, the network handover enhancement method is performed in the regenerative satellite based NG-RAN architecture with the gNB processed payload, and the regenerative satellite based NG-RAN architecture comprises a regenerative satellite with an inter satellite link (ISL) or the regenerative satellite without the ISL.

9. The network handover enhancement method according to claim 6, wherein if the serving/source node comprises the serving/source base station, and the one or more target nodes comprises the one or more target base stations, the network handover enhancement method is performed in the transparent satellite based NG-RAN architecture or the regenerative satellite based NG-RAN architecture with the gNB-DU processed payload.

10. The network handover enhancement method according to claim 1, wherein the handover procedure comprises a normal handover or a conditional handover.

11. The network handover enhancement method according to claim 1, wherein transmitting, by the network node to the serving/source node and the one or more target nodes, the data before the handover procedure further comprises:
transmitting, by the network node to the serving/source node and the one or more target nodes, the data before a handover decision;
transmitting, by the network node to the serving/source node and the one or more target nodes, the data before the handover decision and after a handover preparation; or
transmitting, by the network node to the serving/source node and the one or more target nodes, the data before the handover decision, after the handover preparation, and after the serving/source node transmitting an indication to the network node.

12. The network handover enhancement method according to claim 1, wherein the network node comprises a core network (CN) or a gateway.

13. The network handover enhancement method according to claim 1, further comprising determining if a packet status is transmitted from the serving/source node to the one or more target nodes.

14. The network handover enhancement method according to claim 13, wherein the packet status comprises a packet data convergence protocol (PDCP) sequence number (SN) status.

15. The network handover enhancement method according to claim 13, wherein:
the handover procedure comprises the normal handover;
the data is transmitted from the network node to the serving/source node and the one or more target nodes before the handover decision;
the network node comprises the CN; and
the packet status is transmitted from the serving/source node to the one or more target nodes.

16. The network handover enhancement method according to claim 13, wherein:
the handover procedure comprises the normal handover;
the data is transmitted from the network node to the serving/source node and the one or more target nodes before the handover decision;
the network node comprises the CN; and
none of the packet status is transmitted from the serving/source node to the one or more target nodes.

17. The network handover enhancement method according to claim 13, wherein:
the handover procedure comprises the normal handover;
the data is transmitted from the network node to the serving/source node and the one or more target nodes before the handover decision and after the handover preparation;
the network node comprises the CN; and
the packet status is transmitted from the serving/source node to the one or more target nodes.

18. The network handover enhancement method according to claim 13, wherein:
the handover procedure comprises the normal handover;
the data is transmitted from the network node to the serving/source node and the one or more target nodes before the handover decision and after the handover preparation;
the network node comprises the CN; and
none of the packet status is transmitted from the serving/source node to the one or more target nodes.

19-38. (canceled)

39. A network handover enhancement method by a network node, comprising:
transmitting, by the network node to a serving/source node and one or more target nodes, data before a handover procedure.

40. (canceled)

41. A network node, comprising:
a memory;
a transceiver; and
a processor coupled to the memory and the transceiver;
wherein the transceiver is configured to transmit data to a serving/source node and one or more target nodes before a handover procedure.
